(19) United States
(12) Patent Application Publication
(10) Pub. No.: US 2006/0205911 A1
(43) Pub. Date: Sep. 14, 2006

(54) Allophanate-containing modified polyurethanes

(75) Inventors: Michael Ludewig, Koln (DE); Jan Weikard, Odenthal (DE); Nicolas Stockel, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/369,483

(22) Filed: Mar. 7, 2006

(30) Foreign Application Priority Data
Mar. 11, 2005 (DE) 102005011231.5

(51) Int. Cl. C08G 18/00

(52) U.S. Cl. 528/44

(57) ABSTRACT

The present invention relates to a process for lowering the viscosity of compositions containing compounds having urethane groups, in which all or some of the urethane groups contained therein are reacted with monoisocyanates to form allophanate groups. The present invention also relates to compounds having allophanate groups and compositions containing such compounds, wherein at least 10 mole % of the allophanate groups contained therein correspond to formula I) 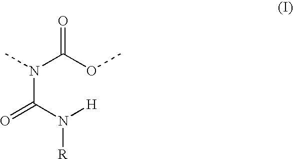 wherein R is an alkyl, aralkyl or aryl radical which has up to 20 carbon atoms and optionally contains heteroatoms and wherein these radicals can also have, in addition to the NCO group present as part of the allophanate group, other functional groups which are neither isocyanate groups nor functional groups derived from isocyanate groups.

### BACKGROUND OF THE INVENTION

1. Field of the Invention

The present invention relates to a process for the preparation of low viscosity allophanates starting from urethanes, to the products obtained by this process and to their use.

2. Description of Related Art

Due to the ecological and economic requirements on modern polyurethane systems of using as little organic solvent as possible or none at all for adjusting the viscosity, there is the wish to use raw materials which are already of low viscosity. Polyisocyanates having allophanate groups, such as are described, inter alia, in EP-B 0 682 012, are known for this pupose.

These allophanates are prepared by the reaction of a mono- or polyhydric alcohol with large amounts of excess aromatic, aliphatic and/or cycloaliphatic diisocyanates (cf. GB-A 994 890, U.S. Pat. No. 3,769,318, EP-E 0 000 194 or EP-A 0 712 840). Exclusively di- or polyisocyanates are employed here, in order to obtain an isocyanate-functional binder. To suppress premature crosslinking, it is necessary to use an excess of polyisocyanate, which must be removed by distillation under vacuum when the urethanization and allophanatization have taken place. In this concept, a further isocyanate group is linked as a functional group via the allophanate nitrogen.

It is also possible to prepare allophanates indirectly, from isocyanate derivatives other than urethanes and isocyanates. Thus, EP-A 0 825 211 describes a process for building up allophanate groups from oxadiazinetriones; a further route is the opening of uretdiones (cf. Proceedings of the International Waterborne, High-Solids, and Powder Coatings Symposium 2001, 28th, 405-419 and US-A 2003 0153713) to give allophanate groups. However, both routes require refined raw materials as the starting material and lead only to an allophanate product rich in by-products. Here also, exclusively at least difunctional polyisocyanates are employed for building up the precursors.

The use of monoisocyanates has also already been disclosed in connection with allophanate chemistry. In U.S. Pat. No. 5,663,272 and U.S. Pat. No. 5,567,793, phenyl isocyanate is used in order to arrive, after reaction with a polyfunctional alcohol, at a urethane which is free from NCO and OH groups, which is subsequently modified by allophanatization with specific MDI types to give a liquid MDI polyisocyanate.

Since the monoisocyanate is employed in the urethanization step and not in the allophanatization, the target structure carries the non-functional radical on the urethane nitrogen atom and not on the allophanate nitrogen atom. The product also contains monomeric diisocyanate before further processing.

It is an object of the present invention to provide a process which can be widely used to prepare polyisocyanate-based raw materials, in particular for the preparation of coatings, adhesives and sealants, in which the viscosity is sufficiently low that the addition of solvent during further processing of these raw materials to form ready-for-application systems is no longer necessary or is only necessary to a reduced extent.

It has now been found that such low viscosity raw materials can be prepared from urethanes if all or some of the urethane groups contained therein are reacted with monoisocyanates to form allophanates. The product which results from this reaction has, from the use point of view, the same advantages and fields of use as the starting material, except that it has a lower viscosity, so that significantly less solvent or none at all has to be employed during further processing. A further advantage is that this procedure can also be used widely on products containing urethane groups which are already established on the market, as a result of which the viscosity thereof can be lowered very easily.

### SUMMARY OF THE INVENTION

The present invention relates to a process for lowering the viscosity of compositions containing compounds having urethane groups, in which all or some of the urethane groups contained therein are reacted with monoisocyanates to form allophanate groups.

The present invention also relates to compounds having allophanate groups and compositions containing such compounds, wherein at least 10 mole % of the allophanate groups contained therein correspond to formula I) 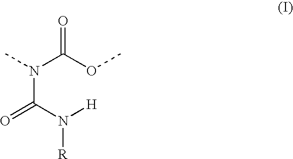
wherein R is an alkyl, aralkyl or aryl radical which has up to 20 carbon atoms and optionally contains heteroatoms and wherein these radicals can also have, in addition to the NCO group present as part of the allophanate group, other functional groups which are neither isocyanate groups nor functional groups derived from isocyanate groups.

### DETAILED DESCRIPTION OF THE INVENTION

The compounds containing allophanate groups according to the invention are prepared by reaction of any desired starting compounds containing urethane groups with monoisocyanates of the formula R-NCO, wherein R is as defined above and is preferably an alkyl radical having 1 to 20 carbon atoms or an aryl radical having 6 to 20 carbon atoms, and wherein the alkyl or aryl radicals can also have, in addition to the NCO group, other functional groups which have neither isocyanate groups nor groups derived from NCO groups.

Examples of suitable monoisocyanates include methyl isocyanate, isopropyl isocyanate, n-butyl isocyanate, tert-butyl isocyanate, n-hexyl isocyanate, cyclohexyl isocyanate, stearyl isocyanate, phenyl isocyanate (incl. chlorinated forms), 1-naphthyl isocyanate, tolyl isocyanate (meta, para and ortho form, incl. fluorinated and chlorinated forms), p-isopropylphenyl isocyanate, 2,6-diisopropylphenyl isocyanate and p-toluenesulfonyl diisocyanate. Preferred monoisocyanates are n-butyl or n-hexyl isocyanate.

The monoisocyanate employed for the allophanate formation can be employed in a less than stoichiometric amount, an equimolar amount or an excess amount, based on the urethane groups present in the starting compound. In the latter case, the excess monoisocyanate must be separated off by a known method, such as distillation or extraction, when the reaction is complete. It is therefore preferred to employ 0.1 to 1.0 mole, preferably 0.5 to 1.0 mole, of monoisocyanate per 1.0 mole of urethane groups of the starting compound.

The allophanatization of the urethane groups by the monoisocyanates is preferably carried out with the use of a catalyst. Suitable allophanatization catalysts are known and include the zinc salts, such as zinc octoate, zinc acetylacetonate and zinc 2-ethylcaproate; or tetraalkylammonium compounds, such as N,N,N-trimethyl-N-2-hydroxypropylammonium hydroxide, N,N,N-trimethyl-N-2-hydroxypropylammonium 2-ethylhexanoate or choline 2-ethylhexanoate. Preferred allophanatization catalysts are zinc octoate and the tetraalkylammonium compounds, more preferably tetraalkylammonium alkanoates and zinc octoate, and most preferably choline 2-ethylhexanoate.

The allophanatization catalyst is employed in amounts of 0.001 to 5.0 wt. %, preferably 0.01 to 1.0 wt. % and more preferably 0.05 to 0.5 wt. %, based on the solids content of the process product.

The allophanatization catalyst can be added in one portion all at once, in several portions or continuously. If unsaturated polymerization-labile groups are present in the reaction mixture, addition in portions or continuously is preferred, in order to avoid temperature peaks and undesirable polymerization reactions of the radiation-curable groups. More preferably, the allophanatization catalyst is added at a rate of 200 to 600 ppm/h and, to bring the allophanatization to completion, stirring of the reaction mixture is continued until the desired NCO content of the end product is reached.

It is also possible to apply the allophanatization catalyst to support materials by known methods and to use it as a heterogeneous catalyst.

For the preferred case in which the monoisocyanate employed for the allophanate formation is employed in a less than stoichiometric or an equimolar amount, based on the urethane groups present in the starting compound, it is preferred to carry out the allophanatization reaction until the NCO content of the product is less than 1.0 wt. %, more preferably less than 0.5 wt. %.

However, for the less preferred case in which an excess of the monoisocyanate is employed for allophanate formation, based on the urethane groups present in the starting compound, it is possible to use an NCO-containing starting compound and to carry out the allophanatization reaction until the desired NCO content of the target compound is reached. In this case, the excess monoisocyanate may be separated off by a known method, such as distillation or extraction, when the reaction is complete.

It is also possible to react a residual content of NCO groups with NCO-reactive compounds, such as alcohols, when the allophanatization reaction has ended. Products having particularly low NCO contents are obtained in this manner.

The allophanatization reaction essential to the invention is carried out at temperatures of 20 to 200° C., preferably 20 to 120° C., more preferably 40 to 100° C., and most preferably 60 to 90° C.

It is irrelevant whether the process according to the invention is carried out continuously, e.g. in a static mixer, extruder or kneader, or discontinuously, e.g. in a stirred reactor. The process according to the invention is preferably carried out in a stirred reactor.

The course of the reaction can be monitored by suitable measuring equipment installed in the reaction vessel and/or analyzing samples taken. Suitable methods are known and include viscosity measurements, measurements of the NCO content, the refractive index or the OH content, gas chromatography (GC), nuclear magnetic resonance spectroscopy (NMR), infra-red spectroscopy (IR) and near infra-red spectroscopy (NIR). IR control for free NCO groups present (for aliphatic NCO groups, band at approx. v=2272 cm⁻¹) and GC analyses for unreacted NCO groups are preferred.

At least 20 mole %, more preferably at least 40 mole %, of the allophanate groups contained in the compounds according to the invention preferably correspond to the group of the formula (I).

The allophanates according to the invention, in particular those based on HDI, preferably have shear viscosities at 23° C. of <150,000 mPa·s, more preferably <80,000 mPa·s.

Suitable starting materials containing urethane groups include all compounds which contain at least one urethane group per molecule, and which possibly also contain free NCO groups. However, they preferably contain no free NCO groups.

Suitable urethanes are conventionally prepared by the reaction of compounds containing isocyanate groups with polyols in an optionally catalyzed addition reaction.

Compounds containing isocyanate groups which are typically employed are aromatic, aliphatic and cycloaliphatic polyisocyanates having a number average molecular weight of less than 800 g/mol. Examples of suitable compounds include diisocyanates such as 2,4-/2,6-toluene diisocyanate (TDI), methylenediphenyl diisocyanate (MDI), triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanate or IPDI), tetra-methylene diisocyanate, hexamethylene diisocyanate (HDI), 2-methylpenta-methylene diisocyanate, 2,2,4-trimethylhexamethylene diisocyanate (THDI), dodecamethylene diisocyanate, 1,4-diisocyanato-cyclohexane, 4,4′-diisocyanato-3,3′-dimethyl-dicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methyl-cyclohexane, 1,3-diisocyanato-2-methyl-cyclohexane and α,α,α′,α′-tetramethyl-m- or -p-xylylene diisocyanate (TMXDI) and mixtures thereof.

Preferred starting substances for the preparation of the compounds containing urethane groups are hexamethylene diisocyanate (HDI), isophorone diisocyanate (IPDI) and/or 4,4′-diisocyanatodicyclohexylmethane, more preferably hexamethylene diisocyanate.

Reaction products of the above-mentioned isocyanates with themselves or with one another to give uretdiones or isocyanurates are also suitable as compounds containing isocyanate. Examples include Desmodur® N3300, Desmodur® N3400 or Desmodur® N3600 (all Bayer MaterialScience, Leverkusen, Del.).

Derivatives of isocyanates, such as allophanates or biurets, are also suitable. Examples include Desmodur® N100, Desmodur® N75 MPA/BA or Desmodur® VPLS2102 (all Bayer MaterialScience, Leverkusen, Del.).

According to the teachings of the German Patent Application DE 10 200 40 488 73, which has not been previously published, functionalized allophanates can also be prepared by a process in which, in a one-pot reaction, isocyanates are first urethanized with a less than stoichiometric amount of a hydroxy-functional compound and are then reacted with an allophanatization catalyst in a further step to give allophanates. In this case, it is possible to subsequently carry out the modification according to the present invention. However, in this case a procedure which is preferred is that in which the monoisocyanate is added to the reaction mixture before the second step, when the urethanization has ended, and the modification according to the invention is carried out in parallel with the allophanatization in accordance with the German Patent Application DE 10 200 40 488 73 which has not been previously published. Such a case is illustrated in Example 1 of the present Application.

Isocyanates can in principle contain compounds which release chlorine or chloride on reaction with water (hydrolysis; compounds with hydrolyzable chlorine). In the process according to the invention, such compounds can lead to a clouding of the resin and an unnecessarily high consumption of catalyst. Isocyanates which contain a content of less than 1,000 ppm of hydrolyzable chlorine are therefore preferably used, more preferably less than 500 ppm, and most preferably less than 200 ppm.

Low and/or higher molecular weight polyols can be employed for the urethanization reaction.

Low molecular weight polyhydroxy compounds which can be used are those known from polyurethane chemistry and having molecular weights of 62 to 399 g/mol. Examples include ethylene glycol, triethylene glycol, tetraethylene glycol, propane-1,2- and -1,3-diol, butane-1,4- and -1,3-diol, hexane-1,6-diol, octane-1,8-diol, neopentylglycol, 1,4-bis(hydroxymethyl)cyclohexane, bis(hydroxymethyl)-tricyclo[5.2.1.0^{2,6}]decane or 1,4-bis(2-hydroxyethoxy)benzene, 2-methyl-1,3-propanediol, 2,2,4-trimethylpentanediol. 2-ethyl-1,3-hexanediol, dipropylene glycol, polypropylene glycols, dibutylene glycol, polybutylene glycols, bisphenol A, tetrabromobisphenol A, glycerol, trimethylolpropane, hexane-1,2,6-triol, butane-1,2,4-triol, pentaerythritol, quinitol, mannitol, sorbitol, methyl glycoside and 4,3,6-dianhydrohexitols.

Higher molecular weight hydroxy compounds include the known hydroxyl polyesters, hydroxyl polyethers, hydroxyl polythioethers, hydroxyl polyacetals, hydroxyl polycarbonates, dimer fatty alcohols and/or ester-amides from polyurethane chemistry, in each case having number average molecular weights of 400 to 18,000 g/mol, preferably 500to 6,500 g/mol. Preferred higher molecular weight hydroxy compounds are the hydroxyl polyethers, hydroxyl polyesters and hydroxyl polycarbonates.

Suitable polyether polyols are known from polyurethane chemistry and include the addition or mixed addition of tetrahydrofuran, styrene oxide, ethylene oxide, propylene oxide, the butylene oxides or epichlorohydrin, preferably ethylene oxide and/or of propylene oxide, onto di- to hexafunctional starter molecules, such as water, the above-mentioned polyols, or amines containing 1 to 4 NH bonds. Propylene oxide polyethers which contain on average 2 to 4 hydroxyl groups and can contain up to 50 wt. % of incorporated polyethylene oxide units are preferred. It is possible to employ both conventional polyethers which are prepared by catalysis with e.g. potassium hydroxide, and polyethers which are prepared with the newer processes using double metal cyanide catalysts. The latter polyethers have a particularly low content of terminal unsaturation of less than 0.07 meq/g, contain significantly less monools and have a low polydispersity of less than 1.5. The polyethers prepared by double metal cyanide catalysis are preferred polyethers.

Suitable polyester polyols include reaction products of polyhydric, preferably dihydric and optionally additionally trihydric alcohols, with polybasic, preferably dibasic carboxylic acids. Instead of the free polycarboxylic acids, the corresponding polycarboxylic acid anhydrides, the corresponding polycarboxylic acid esters of lower alcohols or mixtures thereof can also be used for the preparation of the polyesters. The polycarboxylic acids can be aliphatic, cycloaliphatic, aromatic and/or heterocyclic in nature and can optionally be substituted, e.g. by halogen atoms, and/or unsaturated. Examples which may be mentioned are adipic acid, phthalic acid, isophthalic acid, succinic acid, suberic acid, azelaic acid, sebacic acid, trimellitic acid, phthalic anhydride, tetrahydrophthalic anhydride, glutaric anhydride, tetrachlorophthalic anhydride, endomethylenetetrahydrophthalic anhydride, maleic anhydride, maleic acid, fumaric acid, dimeric and trimeric fatty acids such as oleic acid (optionally in admixture with monomeric fatty acids), terephthalic acid dimethyl ester or terephthalic acid bis-glycol ester. Hydroxy polyesters which have 2 or 3 terminal OH groups and melt below 60° C. are preferred.

Suitable polycarbonate polyols are obtained by the reaction of carbonic acid derivatives, e.g. diphenyl carbonate, dimethyl carbonate or phosgene, with diols. Suitable diols include ethylene glycol, triethylene glycol, tetraethylene glycol, propane-1,2- and -1.3-diol, butane-1,4- and -1,3-diol, pentane-1,5-diol, hexane-1,6-diol, octane-1,8-diol, neopentylglycol, 1,4-his(hydroxymethyl)cyclohexane, bis(hydroxymethyl)tricyclo[5.2.1.0^{2,6}]decane or 1,4-bis(2-hydroxyethoxy)-benzene, 2-methyl-1,3-propanediol, 2,2,4-trimethylpentanediol, dipropylene glycol, polypropylene glycols, dibutylene glycol, polybutylene glycols, bisphenol A, tetrabromobisphenol A or mixtures thereof. Preferably, the diol component contains 40 to 100 wt. % of hexanediol, preferably hexane-1,6-diol, and/or hexanediol derivatives, preferably those which contain ether or ester groups in addition to terminal OH groups. Examples are products which have been obtained by the reaction of 1 mole of hexanediol with at least 1 mole, preferably 1 to 2 moles of caprolactone in accordance with DE-A 1 770 245, or by etherification of hexanediol with itself to give di- or trihexylene glycol. The preparation of such derivatives is known e.g. from DE-A 1 570 540. The polyether-polycarbonate diols described in DE-A 3 717 060 can also be employed.

The hydroxyl polycarbonates should be substantially linear. However, they can also optionally be slightly branched by incorporation of polyfunctional components, in particular low molecular weight polyols. Examples include trimethylolpropane, hexane-1,2,6-triol, glycerol, butane-1,2,4-triol, pentaerythritol, quinitol, mannitol, sorbitol, methyl glycoside and 4,3,6-dianhydrohexitols.

In addition, compounds which also carry still other functional groups in addition to one or more OH groups can also be employed. In this context, those functional groups which can react with polymerization under the action of actinic radiation, (radiation-curable or actinically curable groups) are preferred. Actinic radiation is understood as meaning electromagnetic, ionizing radiation, in particular electron beams, UV rays and visible light (Roche Lexikon Medizin, 4th edition; Urban & Fischer Verlag, Munich 1999).

In the context of the present invention, groups which react with ethylenically unsaturated compounds with polymerization under the action of actinic radiation (radiation-curable groups) are understood as meaning vinyl ether, maleyl, fumaryl, maleimide, dicyclopentadienyl, acrylamide, acryl and methacryl groups, preferably vinyl ether, acrylate and/or methacrylate groups, more preferably acrylate groups.

Examples of such compounds which contain hydroxyl groups and have radiation-curable groups are 2-hydroxyethyl (meth)acrylate, polyethylene oxide mono(meth)acrylate (e.g. PEA6/PEM6; Laporte Performance Chemicals Ltd., UK), polypropylene oxide mono(meth)acrylate, e.g. PPA6, PPM5S; Laporte Performance Chemicals Ltd., UK), polyalkylene oxide mono(meth)acrylate (e.g. PEM63P, Laporte Performance Chemicals Ltd., UK), poly(ε-caprolactone) mono(meth)acrylates, such as e.g. Tone M100 (Dow, Schwalbach, Del.), 2-hydroxypropyl (meth)acrylate, 4-hydroxybutyl (meth)acrylate, hydroxybutyl vinyl ether and 3-hydroxy-2,2-dimethylpropyl (meth)acrylate. Also suitable are the hydroxy-functional mono-, di- or higher functional acrylates, such as glycerol di(meth)acrylate, trimethylolpropane di(meth)acrylate, pentaerythritol tri(meth)acrylate or dipentaerythritol penta(meth)acrylate, which may be prepared by the reaction of polyhydric optionally alkoxylated alcohols, such as trimethylolpropane, glycerol, pentaerythritol or dipentaerythritol.

The reaction products of acids containing double bonds with epoxide compounds which optionally contain double bonds, such as the reaction products of (meth)acrylic acid with glycidyl (meth)acrylate or bisphenol A diglycidyl ether, can also be employed in the urethanization as OH-functional compounds which contain radiation-curable groups.

Unsaturated alcohols which are obtained from the reaction of optionally unsaturated acid anhydrides with hydroxy and epoxy compounds which optionally contain acrylate groups can also be employed in the urethanization of unsaturated alcohols. These include the reaction products of maleic anhydride with 2-hydroxyethyl (meth)acrylate and glycidyl (meth)acrylate.

Preferably, hydroxyethyl (meth)acrylate, hydroxypropyl (meth)acrylate, hydroxybutyl (meth)acrylate and 3-acryloyloxy-2-hydroxypropyl methacrylate (GAMA), more preferably hydroxyethyl acrylate and hydroxypropyl acrylate, are employed for urethane formation.

In preparing the urethane starting materials, it is also possible, in addition to OH-functional compounds, to employ other isocyanate-reactive compounds to prepare the compound containing urethane groups.

In a preferred embodiment of the invention, the compounds which contain urethane groups are built up from components of the above-mentioned type which contain at least one radiation-curable group per molecule.

Before or after allophanate formation, if free NCO groups are present in the compounds which are to be allophanatized, all or some of these can be blocked with the blocking agents which are known in the art. The blocking agents, suitable catalysts that may be necessary and the process conditions are known or can be determined by routine experiments.

Solvents or reactive diluents can be employed both during urethane formation and allophanate formation by the monoisocyanates R—NCO. Suitable solvents are inert to the functional groups present in the process product from the time of the addition to the end of the process. Suitable solvents include the solvents used in the coatings industry, such as hydrocarbons, ketones' and esters. Examples include toluene, xylene, isooctane, acetone, butanone, methyl isobutyl ketone, ethyl acetate, butyl acetate, tetrahydrofuran, N-methylpyrrolidone, dimethylacetamide and dimethylformamide. Preferably no solvent is added.

It is also possible, in particular if the compounds which contain urethane groups and are to be allophanatized contain radiation-curable groups, to use reactive diluents, since viscosity adjustments are possible in this way without increasing the VOC content. Such reactive diluents are described by way of example in P. K. T. Oldring (ed.), Chemistry & Technology, of UV & EB Formulations For Coatings, Inks & Paints, vol. 2, 1991, SITA Technology, London, p. 237-285. Examples include esters of acrylic acid or methacrylic acid, preferably acrylic acid, with mono- or polyfunctional alcohols. Suitable alcohols include the isomeric butanols, pentanols, hexanols, heptanols, octanols, nonanols and decanols; cycloaliphatic alcohols such as isoborneol, cyclohexanol and alkylated cyclohexanols and dicyclopentanol; and arylaliphatic alcohols such as phenoxyethanol, nonylphenylethanol and tetrahydrofurfuryl alcohols. Alkoxylated derivatives of the preceding alcohols can also be used.

Suitable dihydric alcohols include ethylene glycol, propane-1,2-diol, propane-1,3-diol, diethylene glycol, dipropylene glycol, the isomeric butanediols, neopentylglycol, hexane-1,6-diol, 2-ethylhexanediol and tripropylene glycol, or the alkoxylated derivatives of these alcohols. Preferred dihydric alcohols include hexane-1,6-diol, dipropylene glycol and tripropylene glycol. Suitable trihydric alcohols are glycerol, trimethylolpropane or alkoxylated derivatives thereof. Tetrahydric alcohols are pentaerythritol or alkoxylated derivatives thereof.

In the case where the compounds containing urethane groups also contain radiation-curable groups, it is appropriate to add stabilizers during or after urethane formation in order to prevent premature polymerization. Such stabilizers can also be added for the first time or additionally during subsequent allophanate formation.

A preferred stabilizer is phenothiazine. Other suitable stabilizers include phenols, such as para-methoxyphenol, 2,5-di-tert-butylhydroquinone or 2,6-di-tert-butyl-4-methylphenol. N-oxy compounds are also suitable for stabilization such as 2,2,6,6-tetramethylpiperidine N-oxide (TEMPO) or its derivatives. The stabilizers can also be incorporated chemically into the binder. In this context compounds of the above-mentioned classes are suitable if they also carry other free aliphatic alcohol groups or primary or secondary amine groups and therefore can be bonded chemically to the compounds of component A) via urethane or urea groups. 2,2,6,6-tetramethyl-4-hydroxy-piperidine N-oxide is particularly suitable for this embodiment.

Compounds of the class of HALS (HALS=hindered amine light stabilizers) are less suitable as stabilizers since it is known that they are not effective stabilizers, but rather can lead to an “insidious” free-radical polymerization of unsaturated groups.

The stabilizers are chosen such that they are stable under the influence of the allophanatization catalyst and do not react with a component of the process according to the invention under the reaction conditions. This can lead to a loss of the stabilizing property.

For stabilization of the reaction mixture against premature polymerization, in particular if unsaturated radiation-curable groups are present, an oxygen-containing gas, preferably air, can be passed into and/or over the reaction mixture during urethanization and/or allophanatization. It is preferred for the gas to have a moisture content which is as low as possible, in order to prevent undesirable reaction in the presence of isocyanate.

In a preferred embodiment, if low viscosity radiation-curable compounds are to be prepared, a stabilizer of the above-mentioned type is added during urethanization and subsequent allophanatization, and finally, after allophanatization, in order to achieve a long-term stability. Post-stabilization is also carried out with a phenolic stabilizer and if appropriate the reaction product is saturated with air.

The stabilizer is typically employed in amounts of 0.001 to 5.0 wt. %, preferably 0.01 to 2.0 wt. % and more preferably 0.05 to 1.0 wt. %, based on the solids content of the process product.

The allophanates according to the invention can be used for the preparation of coatings as well as adhesives, printing inks, casting resins, dental compositions, sizes, photoresists, stereolithography systems, resins for composite materials and sealing compositions. In the case of gluing or sealing, however, for crosslinking via radiation-curable groups it is a prerequisite that at least one of the two substrates to be glued or to be sealed off with respect to one another must be permeable to UV radiation, i.e., as a rule transparent. In the case of electron beams, an adequate permeability to electrons must be ensured.

The coating compositions according to the invention are applied to the material to be coated using the known methods of coating technology, such as spraying, knife-coating, rolling, pouring, dipping, whirler-coating, brushing or atomizing, or by printing techniques, such as screen, gravure, flexographic or offset printing or by transfer methods.

Suitable substrates for coating or gluing include wood, metal (in particular metal employed in wire, coil, can or container coating), plastic, also in the form of films, in particular ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations according to DIN 7728 Part 1), paper, leather, textiles, felt, glass, wood materials, cork, and inorganically bonded substrates, such as wood and asbestos boards, electronic assemblies or mineral substrates. Substrates which are made of more than one of the above-mentioned materials or substrates which are already coated can also be coated, such as vehicles, aircraft or ships and parts therefor in particular vehicle bodies or attachments. It is also possible to apply the coating composition only temporarily to a substrate, subsequently to cure it partly or completely and optionally to detach it again, in order to produce e.g. films.

The allophanatization according to the invention is particularly advantageous for gentle preparation of components for radiation-curable coating compositions, adhesives or sealants which are either solely radiation-curable or so-called dual-cure systems, in which a combined curing takes place by radiation curing and crosslinking to form urethane or urea groups.

The present invention therefore also provides coating compositions containing
a) one or more of the allophanates according to the invention which contain at least one radiation-curable group per molecule,
b) optionally one or more polyisocyanates having free or blocked isocyanate groups, which are free from radiation-curable groups,
c) optionally compounds other than a) having radiation-curable groups, which optionally contain free or blocked NCO groups,
d) optionally one or more compounds containing isocyanate reactive groups,
e) initiators,
f) optionally solvents and
g) optionally additives.

The polyisocyanates of component b) are known and preferably include hexamethylene diisocyanate, isophorone diisocyanate, 4,4′-diisocyanatodicyclohexylmethane and/or trimethylhexamethylene diisocyanate, the preceding diisocyanate being optionally modified to contain isocyanurate, allophanate, biuret, uretdione and/or iminooxadiazine dione groups.

Compounds c) include urethane acrylates, preferably prepared from hexamethylene diisocyanate, isophorone diisocyanate, 4,4′-diisocyanato-dicyclohexylmethane and/or trimethylhexamethylene diisocyanate, which can optionally be modified to contain isocyanurate, allophanate, biuret, uretdione and/or iminooxadiazine dione groups and which do not contain isocyanate-reactive groups.

NCO-containing urethane acrylates are commercially obtainable from Bayer MaterialScience AG, Leverkusen, Del. as Roskydal® UA VP LS 2337, Roskydal® UA VP LS 2396 or Roskydal® UA XP 2510.

The reactive diluents which have already been described and are known in the art of radiation-curable coatings can also be used as component c), provided that they do not contain isocyanate-reactive groups.

Compounds d) can be saturated or unsaturated. Isocyanate-reactive groups include hydroxyl, amine or thiol groups. Saturated polyhydroxy compounds are preferred, e.g. the polyether polyols, polyester polyols, polycarbonate polyols, poly(meth)acrylate polyols and polyurethane polyols which are known from the technology of coating, adhesive, printings inks or sealing compositions and contain no groups which react with ethylenically unsaturated compounds with polymerization under the action of actinic radiation.

Unsaturated hydroxy-functional compounds include the epoxy acrylates, polyester acrylates, polyether acrylates, urethane acrylates and acrylated polyacrylates which are known in the art of radiation-curable coatings and have an OH number of 30 to 300 mg of KOH/g.

The reactive diluents which have already been described and are known in the art of radiation-curable coatings can also be used as component d) as long as they do contain isocyanate-reactive groups.

Initiators which can be activated by radiation and/or thermally can be employed as initiators e) for free-radical polymerization. Photoinitiators which are activated by UV or visible light are preferred. Photoinitiators include known, commercially available compounds; there is a distinction between unimolecular (type I) and bimolecular (type II) initiators. Suitable (type I) systems are aromatic ketone compounds such as benzophenones in combination with tertiary amines, alkylbenzophenones, 4,4′-bis(dimethylamino)benzophenone (Michler's ketone), anthrone and halogenated benzophenones or mixtures thereof. (Type II) initiators include benzoin and its derivatives, benzil ketals, acylphosphine oxides (e.g. 2,4,6-trimethyl-benzoyl-diphenylphosphine oxide or bisacylphosphine oxides), phenylglyoxylic acid esters, camphorquinone, α-aminoalkylphenones, α,α-dialkoxyacetophenones and α-hydroxyalkylphenones.

The initiators are employed in amounts of 0.1 to 10 wt. %, preferably 0.1 to 5 wt. %, based on the weight of the coating binder. The initiators can be used individually or, because of frequent advantageous synergistic effects, in combination with one another.

If electron beams are used instead of UV radiation, no photoinitiator is required. Electron beams are generated by means of thermal emission and are accelerated via a potential difference. The high-energy electrons then break through a titanium film and are directed to the binder to be cured. The general principles of curing with electron beams are described in detail in “Chemistry & Technology of UV & EB Formulations for Coatings, Inks & Paints”, vol. 1, P. K. T. Oldring (ed.), SITA Technology, London, England, p. 101-157, 1991.

Thermal curing of the activated double bonds can also be carried out with the addition of thermally dissociating agents which form free radicals. Suitable agents are known and include peroxy compounds, for example, dialkoxy dicarbonates such as bis(4-tert-butylcyclohexyl) peroxydicarbonate; dialkyl peroxides such as dilauryl peroxide; peresters of aromatic or aliphatic acids such as tert-butyl perbenzoate or tert-amyl peroxy-2-ethylhexanoate; inorganic peroxides such as ammonium peroxodisulfate or potassium peroxodisulfate; organic peroxides such as 2,2-bis(tert-butylperoxy)butane, dicumyl peroxide or tert-butyl hydroperoxide; and azo compounds such as 2,2′-azobis[N-(2-propenyl)-2-methylpropionamide], 1-[(cyano-1-methylethyl)azo]formamide, 2,2′-azobis(N-butyl-2-methylpropionamide), 2,2′-azobis(N-cyclohexyl-2-methylpropionamide), 2,2′-azobis {2-methyl-N-[2-(1-hydroxybutyl)]propionamide}, 2,2′-azobis {2-methyl-N-[2-(1-hydroxybutyl)]propionamide and 2,2′-azobis {2-methyl-N-[1,1-bis(hydroxymethyl)-2-hydroxyethyl]propionamide. Also suitable are highly substituted 1,2-diphenylethanes (benzopinacoles) such as 3,4-dimethyl-3,4-diphenylhexane, 1,1,2,2-tetraphenyl-ethane-1,2-diol or also silylated derivatives thereof.

It is also possible to use a combination of initiators which can be activated by UV light and initiators which can be activated thermally.

Solvents f) include the solvents previously mentioned.

Additives g) include UV absorbers and/or HALS stabilizers to increase the stability of the cured coating to weather. The combination is preferred. The UV absorbers should have an absorption range of not more than 390 nm and include triphenyltriazine types (e.g. Tinuvin®0 400 (Ciba Spezialitatenchemie GmbH, Lampertheim, Del.)), benzotriazoles (e.g. Tinuvin® 622 (Ciba Spezialitatenchemie GmbH, Lampertheim, Del.)) or oxalic acid dianilides (e.g. Sanduvor® 3206 (Clariant, Muttenz, CH)). They are added in an amount of 0.5 to 3.5 wt. %, based on the solid resin. Suitable HALS stabilizers are known and include Tinuvin® 292 or Tinuvin® 123 (Ciba Spezialitatenchemie GmbH, Lampertheim, Del.) or Sanduvor® 3258 (Clariant, Muttenz, CH). Preferred amounts are 0.5 to 2.5 wt. %, based on the solid resin.

Additives g) also include pigments, dyestuffs, fillers, flow and deaerating additives, and the catalysts known from polyurethane chemistry for accelerating the NCO/OH reaction. Examples include tin salts, zinc salts, organotin compounds, tin soaps and/or zinc soaps, such as tin octoate, dibutyltin dilaurate or dibutyltin oxide; or tertiary amines, such as diazabicyclo[2,2,2]octane (DABCO).

After application, for curing, all or some of the solvent contained in the composition can be removed by evaporation in air. Subsequently or simultaneously, the thermal curing process(es) which may be necessary and the photochemical curing process(es) can be carried out successively or simultaneously. If necessary, thermal curing can be carried out at room temperature, but preferably at elevated temperature of 40 to 160° C., more preferably 60 to 130° C. and most preferably at 80 to 110° C.

If photoinitiators are used in d), the radiation curing is preferably carried out using high-energy radiation, i.e., UV radiation or daylight, e.g. light having a wavelength or 200 to 700 nm, or by irradiation with high-energy electrons (electron beams, 150 to 300 keV). High- or medium-pressure mercury vapor lamps, for example, serve as sources of radiation for light or UV light. It is possible for the mercury vapor to be modified by doping with other elements, such as gallium or iron. Lasers, pulsed lamps (known by the name UV flash lamps), halogen lamps or eximer lamps are also suitable. The lamps can be equipped as a result of the design or by the use of specific filters and/or reflectors such that the emergence of part of the UV spectrum is prevented. For example, the radiation assigned to UV-C and UV-B can be filtered out e.g. for industrial hygiene reasons. The lamps can be installed immovably, so that the goods to be irradiated are passed by the source of radiation by means of a mechanical device, or the lamps can be movable and the goods to be irradiated can be stationary during curing. The radiation dose which is conventionally sufficient for UV curing is in the range of 80 to 5,000 mJ/cm².

Irradiation can optionally also be carried out with exclusion of oxygen, e.g. under an inert gas atmosphere or oxygen-reduced atmosphere. Suitable inert gases are preferably nitrogen, carbon dioxide, noble gases or combustion gases. The irradiation can also take place by covering the coating with media which are transparent for the radiation. Examples include films of plastic, glass or liquids, such as water.

The type and concentration of the initiator optionally used can be varied in known manner according to the radiation dose and curing conditions. High-pressure mercury lamps in fixed installations are preferably employed for the curing. Photoinitiators are then employed in concentrations of 0.1 to 10 wt. %, more preferably 0.2 to 3.0 wt. %, based on the resin solids content of the coating. A dose of 200 to 3,000 mJ/cm² measured in the wavelength range of 200 to 600 nm is preferably used for curing these coatings.

If thermally activatable initiators are used in d) the curing is carried out by increasing the temperature. The thermal energy can be introduced into the coating in this context by radiation, thermal conduction and/or convection using the infra-red lamps, near infra-red lamp or ovens known from coating technology.

The layer thicknesses applied (before curing) are typically 0.5 to 5,000 μm, preferably 5 to 1,000 μm, more preferably 15 to 200 μm. When solvents are used, they are removed by known methods after application and before curing.

### EXAMPLES

All the percentage data relate to percent by weight, unless stated otherwise.

The determination of the NCO contents in % was carried out via back-titration with 0.1 mol hydrochloric acid after reaction with butylamine, based on DIN EN ISO 11909.

The viscosity measurements were carried out with a plate-plate rotary viscometer, RotoVisko 1 from Haake, Del., in accordance with ISO/DIS 3219:1990.

The ambient temperature of 23° C. prevailing at the time of conducting the experiments is called RT.

Preparation of Choline 2-ethylhexanoate

83 g of sodium 2-ethylhexanoate were dissolved in 600 ml of Methanol at RT in a 1,000 ml of glass flask equipped with a stirring device. 69.8 g of choline chloride were then added in portions and the mixture was stirred at room temperature for a further 10 hours. The precipitate formed was filtered off and the solution was concentrated to about one third on a rotary evaporator under reduced pressure until a precipitate formed again. The concentrate was diluted with about 400 ml of acetone and filtered again and the solvent was stripped off again under reduced pressure. The residue which remained was taken up again in about 400 ml of acetone, the mixture was filtered and the solvent was stripped off. 117 g of a crystallization-stable liquid product were obtained, the product being employed as an allophanatization catalyst in this form.

### Example 1

### Allophanate-Containing Binder According to the Invention

175.77 g of hexamethylene diisocyanate (Desmodur® H, Bayer MaterialScience, Leverkusen, Del.) and 50 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen) were added and 203.79 g of hydroxypropyl acrylate were added dropwise such that the temperature did not exceed 80° C. The mixture was subsequently stirred until the theoretical NCO content of 5.77% was reached. 119.61 g of hexyl isocyanate were then added, the temperature was increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.74%, which was reacted by adding 2.6 g of methanol and stirring at 60° C. for two hours. A colorless resin having a residual NCO content of 0% and a viscosity of 13,000 mPa·s (23° C.) was obtained.

### Example 2

### Allophanate-Containing Binder According to the Invention

185.57 g of hexamethylene diisocyanate (Desmodur® H, Bayer MaterialScience, Leverkusen, Del.) and 25 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen) were added and 215.15 g of hydroxypropyl acrylate were added dropwise such that the temperature did not exceed 80° C. The mixture was subsequently stirred until the theoretical NCO content of 5.77% was reached. 98.48 g of butyl isocyanate (Lanxess, Leverkusen, content of hydrolyzable chlorine approx. 100 ppm) were then added, the temperature was increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.45%, which was reacted by adding 1.7 g of methanol and stirring at 60° C. for two hours. A colorless resin having a residual NCO content of 0% and a viscosity of 25,500 mPa·s (23° C.) was obtained.

### Comparison Example to 1 and 2

### Allophanate-Containing Binder Which is not According to the Invention

231.16 g of hexamethylene diisocyanate (Desmodur® H, Bayer MaterialScience, Leverkusen, Del.) and 50 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen, Del.) were added and 268.01 g of hydroxypropyl acrylate were added dropwise such that the temperature did not exceed 80° C. The mixture was subsequently stirred until the theoretical NCO content of 5.77% was reached; The temperature was then increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. A colorless resin having a residual NCO content of 0.1% and a viscosity of 75,400 mPa·s (23° C.) was obtained.

### Example 3

### Allophanate-Containing Binder According to the Invention

148.62 g of hexamethylene diisocyanate (Desmodur® H, Bayer MaterialScience, Leverkusen, Del.) and 40 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 20 mg of dibutyltin dilaurate (Desmorapid Z, Bayer MaterialScience, Leverkusen, Del.) were added and 160.82 g of hydroxypropyl acrylate were added dropwise such that the temperature did not exceed 80° C. The mixture was subsequently stirred until the theoretical NCO content of 7.18% was reached. 89.90 g of hexyl isocyanate were then added, the temperature was increased to 80° C. and 0.60 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.6%, which was reacted by adding 1.9 g of methanol and stirring at 60° C. for two hours. A colorless resin having a residual NCO content of 0% and a viscosity of 27,100 mPa·s (23° C.) was obtained.

### Example 4

### Allophanate-Containing Binder According to the Invention

195.47 g of hexamethylene diisocyanate (Desmodur® H, Bayer MaterialScience, Leverkusen, Del.) and 25 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen, Del.) were added and 211.52 g of hydroxypropyl acrylate were added dropwise such that the temperature did not exceed 80° C. The mixture was subsequently stirred until the theoretical NCO content of 7.18% was reached. 92.21 g of butyl isocyanate (Lanxess, Leverkusen, content of hydrolyzable chlorine approx. 100 ppm) were then added, the temperature was increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.3%, which was reacted by adding 1.2 g of methanol and stirring at 60° C. for two hours. A colorless resin having a residual NCO content of 0% and a viscosity of 48,000 mPa·s (23° C.) was obtained.

### Comparison Example to 3 and 4

### Allophanate-Containing Binder Which is not According to the Invention

239.74 g of hexamethylene diisocyanate and 50 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate were added and 259.43 g of hydroxypropyl acrylate were added dropwise such that the temperature did not exceed 80° C. The mixture was subsequently stirred until the theoretical NCO content of 7.18% was reached. 0.75 g of choline 2-ethylhexanoate was then metered in slowly at 70° C. over 6 hours. After somewhat more than half the time, a significant exothermicity was recorded, which necessitated cooling of the mixture. Metering was continued, and the mixture was subsequently stirred for another further hour. A colorless resin having a residual NCO content of 0.0% and a viscosity of 125,000 mPa·s (23° C.) was obtained.

### Example 5

### Allophanate-Containing Binder According to the Invention

194.52 g of hexamethylene diisocyanate (Desmodur® H, Bayer MaterialScience, Leverkusen, Del.) and 25 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen) were added and 201.45 g of hydroxyethyl acrylate were added dropwise such that the temperature did not exceed 80° C. The mixture was subsequently stirred until the theoretical NCO content of 6.13% was reached. 103.23 g of butyl isocyanate (Lanxess, Leverkusen, Del., content of hydrolyzable chlorine approx. 100 ppm) were then added, the temperature was increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.51%, which was reacted by adding 2.0 g of methanol and stirring at 60° C. for two hours. A colorless resin having a residual NCO content of 0% and a viscosity of 12,000 mPa·s (23° C.) was obtained.

### Example 6

### Allophanate-Containing Binder According to the Invention

177.24 g of hexamethylene diisocyanate (Desmodur® H, Bayer MaterialScience, Leverkusen, Del.) and 25 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen) were added and 227.90 g of hydroxybutyl acrylate were added dropwise such that the temperature did not exceed 80° C. The mixture was subsequently stirred until the theoretical NCO content of 5.46% was reached. 94.06 g of butyl isocyanate (Lanxess, Leverkusen, Del., content of hydrolyzable chlorine approx. 100 ppm) were then added, the temperature was increased to 80° C. and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.33%, which was reacted by adding 1.3 g of methanol and stirring at 60° C. for two hours. A colorless resin having a residual NCO content of 0% and a viscosity of 3,800 mPa·s (23° C.) was obtained.

### Example 7

### Allophanate-Containing Binder According to the Invention

137.42 g of hexamethylene diisocyanate (Desmodur® H, Bayer MaterialScience, Leverkusen, Del.) and 15 mg of phenothiazine were initially introduced into a 500 ml, four-necked glass flask equipped with a reflux condenser, heatable oil bath, mechanical stirrer, air throughput (1/h), internal thermometer and dropping funnel and were heated to 70° C. 25 mg of dibutyltin dilaurate (Desmorapid Z, Bayer MaterialScience, Leverkusen, Del.) were added and 288.87 g of 3-acryloyloxy-2-hydroxypropyl methacrylate (GAMA, preparation according to DE 10 35 77 12.2, Example 17) were added dropwise such that the temperature did not exceed 80° C. The mixture was subsequently stirred until the theoretical NCO content of 4.02% was reached. 72.92 g of butyl isocyanate (Lanxess, Leverkusen, Del., content of hydrolyzable chlorine approx. 100 ppm) were then added, the temperature was increased to 80° C. and 2.25 g of choline 2-ethylhexanoate were metered in slowly over 9 hours. After somewhat more than half the time, a significant exothermicity was recorded, which necessitated cooling of the mixture. Metering was continued, and the mixture was subsequently stirred for a further two hours. The colorless resin still had an NCO content of 0.67%, which was reacted by adding 2.25 g of methanol and stirring at 60° C. for two hours. A colorless resin having a residual NCO content of 0% and a viscosity of 10,000 mPa·s (23° C.) was obtained.

### Comparison Example to 7

### Allophanate-Containing Binder Which is not According to the Invention

160.92 g of hexamethylene diisocyanate (Desmodur® H, Bayer MaterialScience, Leverkusen, Del.) and 15 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen, Del.) were added and 338.29 g of 3-acryloyloxy-2-hydroxypropyl methacrylate (GAMA, preparation according to DE 10 35 77 12.2, Example 17) were added dropwise such that the temperature did not exceed 80° C. The mixture was subsequently stirred until the theoretical NCO content of 4.02% was reached. 2.25 g of choline 2-ethylhexanoate were then metered in slowly over 9 hours. After somewhat more than half the time, a significant exothermicity was recorded, which necessitated cooling of the mixture. Metering was continued, and the mixture was subsequently stirred for a further two hours. The colorless resin still had an NCO content of 0.24%, which was reacted by adding 1.3 g of ethanol and stirring at 60° C. for two hours. A colorless resin having a residual NCO content of 0% and a viscosity, which was determined only with difficulty, of 420,000 mPa·s (23° C.) was obtained.

### Example 8

### Allophanate- and Isocyanurate-Containing Binder According to the Invention

949.60 g of a polyisocyanate prepared from HDI and containing isocyanurate groups (Desmodur® N3600, Bayer MaterialScience, Leverkusen, Del.), 200 mg of phenothiazine, 1.99 g of 2,6-di-tert-butyl-4-methylphenol and 1.49 g of dibutyltin dilaurate (Desmorapid Z, Bayer MaterialScience, Leverkusen, Del.) were initially introduced into a 2,000 ml, four-necked glass flask equipped with a reflux condenser, heatable oil bath, mechanical stirrer, air throughput, internal thermometer and dropping funnel and were heated to 60° C. 167.73 g of hydroxypropyl acrylate and, subsequently, 349.22 g of hydroxyethyl acrylate were then added dropwise such that the temperature did not exceed 65° C. The excess isocyanate was then reacted with 62.88 g of 2-ethylhexanediol. The mixture was subsequently stirred until an NCO content was no longer detected. 6.96 g of choline 2-ethylhexanoate and then 459.83 g of butyl isocyanate (Lanxess, Leverkusen, Del., content of hydrolyzable chlorine approx. 100 ppm) were added and the temperature was increased to 80° C. After about one hour, a significant exothermicity was recorded, which necessitated cooling of the mixture. The mixture was subsequently stirred for a further two hours. The resulting colorless resin was diluted with 500 g of hexanediol diacrylate. The product had a viscosity of 9,800 mPa·s (23° C.).

### Comparison Example to 8

### Isocyanurate-Containing Binder Which is not According to the Invention

744.21 g of a polyisocyanate prepared from HDI and containing isocyanurate groups (Desmodur® N3600, Bayer MaterialScience, Leverkusen, Del.), 300 g of hexanediol diacrylate, 1.20 g of 2,6-di-tert-butyl-4-methylphenol and 0.09 g of dibutyltin dilaurate (Desmorapid Z, Bayer MaterialScience, Leverkusen, Del.) were initially introduced into a 2,000 ml, four-necked glass flask equipped with a reflux condenser, heatable oil bath, mechanical stirrer, air throughput, internal thermometer and dropping funnel and were heated to 60° C. 131.45 g of hydroxypropyl acrylate and, subsequently, 273.69 g of hydroxyethyl acrylate were added dropwise such that the temperature did not exceed 65° C. The excess isocyanate was then reacted with 49.28 g of 2-ethylhexanediol. The mixture was subsequently stirred until an NCO content was no longer detected. A colorless resin having a viscosity of 21,100 mPa·s (23° C.) was obtained.

### Example 9

### Allophanate-Containing Binder According to the Invention

124.59 g of hexamethylene diisocyanate (Desmodur® H, Bayer MaterialScience, Leverkusen, Del.), 0.15 g of phenothiazine and 0.375 g of dibutyltin dilaurate (Desmorapid Z, Bayer MaterialScience, Leverkusen) were initially introduced into a 1,000 ml, four-necked glass flask equipped with a reflux condenser, heatable oil bath, mechanical stirrer, air throughput, internal thermometer and dropping funnel and were heated to 70° C. 86.02 g of hydroxyethyl acrylate and, subsequently, 420.2 g of a low viscosity liquid polyester (Oxyester T1136®, Degussa, Marl, Del.) were then added dropwise such that the temperature did not exceed 85° C. and the mixture was stirred until residual NCO was no longer detected. A sample taken for measurement of the viscosity became solid at room temperature (comparison value). 117.54 g of butyl isocyanate (Lanxess, Leverkusen, Del., content of hydrolyzable chlorine approx. 100 ppm) were then added, the temperature was increased to 80° C., and 2.25 g of choline 2-ethylhexanoate were metered in slowly over 9 hours. After somewhat more than half the time, a significant exothermicity was recorded, which necessitated cooling of the mixture. Metering was continued, and the mixture was subsequently stirred for a further two hours. The colorless resin still had an NCO content of 0.54%, which was reacted by adding 3.08 g of methanol and stirring at 60° C. for two hours. A colorless resin having a residual NCO content of 0% and a viscosity of 41,400 mPa·s (23° C.) was obtained.

### Example 10

### Allophanate-Containing Binder According to the Invention

151.2 g of hexamethylene diisocyanate (Desmodur® H. Bayer MaterialScience, Leverkusen, Del.), 0.21 g of phenothiazine and 0.52 g of dibutyltin dilaurate (Desmorapid Z, Bayer MaterialScience, Leverkusen) were initially introduced into a 2,000 ml of sulfonating beaker equipped with a four-necked ground glass lid, heatable oil bath, mechanical stirrer, air throughput, internal thermometer and dropping funnel and were heated to 80° C. 78.0 g of hydroxypropyl acrylate and, subsequently, 1,359.5 g of a polyester of adipic acid, butanediol, monoethylene glycol and diethylene glycol (Desmophen® 1652fl, Bayer MaterialScience, Leverkusen, Del.) were then added dropwise such that the temperature did not exceed 85° C. and the mixture was stirred until residual NCO was no longer detected. The viscosity of the product at this point was 230,000 mPa·s (23° C.) (comparison value). 148.5 g of butyl isocyanate (Lanxess, Leverkusen, Del., content of hydrolyzable chlorine approx. 100 ppm) and, subsequently, 2.24 g of zinc octoate were then added and the mixture was stirred at 80° C. for 10 hours. A further 2.24 g of zinc octoate were then added and the mixture was stirred for a further ten hours. The remaining residual NCO content of 0.93% was reacted by adding 7.5 g of methanol and stirring at 60° C. for two hours. A resin having a viscosity of 85,000 mPa·s (23° C.) was obtained.

### Example 11

### Allophanate-Containing Binder According to the Invention

145.03 g of hexamethylene diisocyanate (Desmodur® H, Bayer MaterialScience, Leverkusen, Del.) and 25 mg of phenothiazine were initially introduced into a 500 ml, four-necked glass flask equipped with a reflux condenser, heatable oil bath, mechanical stirrer, air throughput, internal thermometer and dropping funnel and were heated to 70° C. 25 mg of dibutyltin dilaurate (Desmorapid Z, Bayer MaterialScience, Leverkusen, Del.) were added and 200.25 g of hydroxyethyl acrylate were added dropwise such that the temperature did not exceed 80° C. The mixture was subsequently stirred until it was free from NCO. A sample taken for measurement of the viscosity became solid at room temperature (comparison value). 153.92 g of butyl isocyanate (Lanxess, Leverkusen, Del., content of hydrolyzable chlorine approx. 100 ppm) were then added, the temperature was increased to 80° C., and 0.75 g of choline 2-ethylhexanoate was metered in slowly over 6 hours. After somewhat more than half the time, a significant exothermicity was recorded, which necessitated cooling of the mixture. Metering was continued, and the mixture was subsequently stirred for a further two hours. The colorless resin still had an NCO content of 0.24%, which was reacted by adding 1.32 g of ethanol and stirring at 60° C. for two hours. A colorless resin having a residual NCO content of 0% and a viscosity of 1,500 mPa·s (23° C.) was obtained.

Summary:

| | | Viscosities | |
|---|---|---|---|
| | | According to | |
| | | the invention | Comparison |
| Examples | 1 | 13,000 mPa · s | 75,400 mPa · s |
| | 2 | 25,500 mPa · s | 75,400 mPa · s |
| | 3 | 27,100 mPa · s | 125,000 mPa · s |
| | 4 | 48,000 mPa · s | 125,000 mPa · s |
| | 5 | 12,000 mPa · s | no test, −> leads to solid product |
| | 6 | 3,800 mPa · s | no test, −> leads to solid product |
| | 7 | 110,000 mPa · s | 420,000 mPa · s |
| | 8 | 9,800 mPa · s | 21,100 mPa · s |
| | 9 | 41,400 mPa · s | leads to solid product |
| | 10 | 85,000 mPa · s | 230,000 mPa · s |
| | 11 | 1,500 mPa · s | leads to solid product |

It can be clearly seen that the non-modified binders have a viscosity that is two to six times higher than the modified binders according to the invention.

### Example 12

### Coating Composition and Coating

A portion of the product from Example 5 was mixed intensively with 5.0% of the photoinitiator Darocur® 1173 (photoinitiator, commercial product from Ciba Spezialitatenchemie GmbH, Lampertheim Del.). The mixture was applied as a thin film to a glass plate by means of a bone doctor knife with a gap of 120 μm. After irradiation with UV (medium-pressure mercury lamp, IST Metz GmbH, Nurtingen, Del., 750 mJ/cm²), a transparent coating which had a Shore A hardness of 126 was obtained.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for lowering the viscosity of a composition containing a compound having urethane groups which comprises reacting all or some of the urethane groups with a monoisocyanate to form allophanate groups.

2. The process of claim 1 the monoisocyanate comprises a member selected from the group consisting of alkyl isocyanates having 1 to 20 carbon atoms in the alkyl radical and aryl isocyanates having 6to 20 carbon atoms in the aryl radical, wherein the alkyl or aryl radicals optionally have, in addition to the NCO group, other functional groups which have neither isocyanate groups nor groups derived from NCO groups.

3. The process of claim 1 wherein the monoisocyanate comprises n-butyl or n-hexyl isocyanate.

4. The process of claim 1 which comprises carrying out the reaction in the presence of an allophanatization catalyst.

5. The process of claim 4 wherein the catalyst comprises a tetraalkyl-ammonium alkanoate or zinc octoate.

6. The process of claim 1 wherein the compound having urethane groups also contains at least one radiation-curable group.

7. The process of claim 2 wherein the compound having urethane groups also contains at least one radiation-curable group.

8. The process of claim 3 wherein the compound having urethane groups also contains at least one radiation-curable group.

9. A compound containing allophanate groups, wherein at least 10 mole % of the allophanate groups contained therein correspond to formula I) 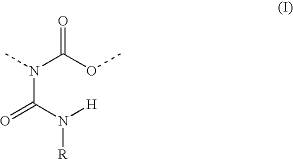
R is an alkyl, aralkyl or aryl radical which has up to 20 carbon atoms and optionally contains heteroatoms and wherein these radicals can also have, in addition to the NCO group present as part of the allophanate group, other functional groups which are neither isocyanate groups nor functional groups derived from isocyanate groups.

10. The compound of claim 9 wherein R is the residue obtained by removing the isocyanate group from n-butyl or n-hexyl isocyanate.

11. The compound of claim 9 wherein at least 40 mole % of the allophanate groups contained therein correspond to formula I).

12. The compound of claim 10 wherein at least 40 mole % of the allophanate groups contained therein correspond to formula I).

13. The compound of claim 9 wherein the compound also contains a radiation-curable group.

14. The compound of claim 10 wherein the compound also contains a radiation-curable group.

15. The compound of claim 11 wherein the compound also contains a radiation-curable group.

16. The compound of claim 12 wherein the compound also contains a radiation-curable group.

17. A coating, adhesive or sealant composition comprising the compound of claim 9 containing allophanate groups.

18. A coating, adhesive or sealant composition comprising the compound of claim 13 containing allophanate groups.

19. A coating composition comprising
a) the compound of claim 13 which contains one or more allophanate groups and one or more radiation-curable groups,
b) optionally a polyisocyanate having free or blocked isocyanate groups, which is free from radiation-curable groups,
c) optionally a compound other than a) which has radiation-curable groups and optionally contains free or blocked NCO groups,
d) optionally a compound containing one or more isocyanate-reactive groups,
e) an initiator,
f) optionally a solvent and
g) optionally an additive.

20. A substrate coated with the coating composition of claim 19.
